(19) United States
(12) Patent Application Publication
(10) Pub. No.: US 2012/0249532 A1
(43) Pub. Date: Oct. 4, 2012

(54) DISPLAY CONTROL DEVICE, DISPLAY CONTROL METHOD, DETECTION DEVICE, DETECTION METHOD, PROGRAM, AND DISPLAY SYSTEM

(75) Inventor: Shigeru KAWADA, Chiba (JP)

(73) Assignee: Sony Corporation, Tokyo (JP)

(21) Appl. No.: 13/408,556

(22) Filed: Feb. 29, 2012

(30) Foreign Application Priority Data
Mar. 28, 2011 (JP) 2011-070673

(51) Int. Cl. G06T 15/00; G09G 5/00

(52) U.S. Cl. 345/419; 345/156

(57) ABSTRACT

According to a first exemplary embodiment, the disclosure is directed to an information processing apparatus that includes an interface that acquires information indicating a distance between a right eye and a left eye of a person, and a processor that determines a recommended viewing condition for a display based on the information indicating the distance between the right eye and the left eye of the person.

### CROSS REFERENCE TO RELATED APPLICATIONS

This application claims the benefit of priority under 35 U.S.C. §119 to Japanese Priority Patent Application JP 2011-070673 filed in the Japan Patent Office on Mar. 28, 2011, the entire contents of which are hereby incorporated by reference.

### BACKGROUND

The present disclosure relates to a display control device, a display control method, a detection device, a detection method, a program, and a display system, and particularly relates to a display control device, a display control method, a detection device, a detection method, a program, and a display system in which it is possible to view and listen to content in a viewing environment that is suited to the user.

There is a stereoscopic display technique of displaying content such as moving images which is configured by a plurality of three-dimensional images on a display (Japanese Unexamined Patent Application Publication No. 11-164328).

Here, a three-dimensional image is configured by a left eye two-dimensional image and a right eye two-dimensional image, and parallax is provided between the left eye two-dimensional image and the right eye two-dimensional image such that an object in a three-dimensional image that the viewer sees appears stereoscopically.

Further, in a case when a three-dimensional image is presented to the viewer, for example, the left eye two-dimensional image is presented to be seen by only the left eye of the viewer, and the right eye two-dimensional image is presented to be seen by only the right eye of the viewer.

The viewer sees an image as a stereoscopic three-dimensional image according to the parallax provided between the left eye two-dimensional image and the right eye two-dimensional image.

### SUMMARY

Generally, the narrower the interocular distance that represents the distance between the left and right pupils, the more stereoscopic the viewer perceives an object in a three-dimensional image.

In turn, creators of content envisage, for example, a viewer with an average interocular distance (for example, a viewer with an interocular distance of 6.5 cm) when creating content as three-dimensional images, and create content that is able to be viewed with the stereoscopic effect that the creator intends when the viewer views the content.

Therefore, depending on the interocular distance of the viewer, there may be a case when it is difficult to view the content with the stereoscopic effect that the creator intended. Therefore, in order for the content to be viewed by the viewer with the stereoscopic effect that the creator extends, content is viewed in different viewing environments (for example, the viewing distance when viewing the content, the size of the display screen that displays the content, or the like) depending on the interocular distance of the viewer.

It is desirable that the content is able to be viewed in a viewing environment that is suitable for the user.

According to a first exemplary embodiment, the disclosure is directed to an information processing apparatus that includes an interface that acquires information indicating a distance between a right eye and a left eye of a person, and a processor that determines a recommended viewing condition for a display based on the information indicating the distance between the right eye and the left eye of the person.

According to another exemplary embodiment, the disclosure is directed to a method performed by an information processing apparatus. The method includes acquiring, by an interface of the information processing apparatus, information indicating a distance between a right eye and a left eye of a person, and determining, by a processor of the information processing apparatus, a recommended viewing condition for a display based on the information indicating a distance between the right eye and the left eye of the person.

According to another exemplary embodiment, the disclosure is directed to a non-transitory computer-readable medium including computer program instructions, which when executed by an information processing apparatus, cause the information processing apparatus to perform a method. The method including acquiring information indicating a distance between a right eye and a left eye of a person, and determining a recommended viewing condition for a display based on the information indicating a distance between the right eye and the left eye of the person.

According to another exemplary embodiment, the disclosure is directed to a detection device. The detection device including a processor that determines information corresponding to a distance between a right eye and a left eye of a person, and an interface that outputs the information corresponding to the distance to another device that determines a recommended viewing condition for a display based on the information indicating a distance between the right eye and the left eye of the person.

According to another exemplary embodiment, the disclosure is directed to a detection method performed by a detection device. The method including determining, by a processor of the detection device, information corresponding to a distance between a right eye and a left eye of a person, and outputting, by an interface of the detection device, the information corresponding to the distance to another device that determines a recommended viewing condition for a display based on the information indicating a distance between the right eye and the left eye of the person.

According to the embodiments of the present disclosure, it is possible to view content in a viewing environment that is suitable for the user.

### BRIEF DESCRIPTION OF THE DRAWINGS

FIG. 1 is a block diagram that illustrates a configuration example of a television set of the embodiments of the present disclosure;

FIG. 2 is a first diagram that illustrates a display example of a display of the television set;

FIG. 3 is a second diagram that illustrates a display example of the display of the television set;

FIG. 4 is a diagram for describing an example of a calculation method of the viewing distance;

FIG. 5 is a flowchart for describing a guiding process that the television set of FIG. 1 performs;

FIG. 6 is a diagram that illustrates an appearance example of 3D glasses;

FIG. 7 is a block diagram that illustrates a configuration example of the 3D glasses,

FIG. 8 is a flowchart for describing an interocular distance transmission process that the 3D glasses perform;

FIG. 9 is a third diagram that illustrates a display example of the display of the television set;

FIG. 10 is a diagram that illustrates the interocular distance that differs by age;

FIGS. 11A and 11B are diagrams that illustrate how the stereoscopic effect of an object in an image differs according to the interocular distance;

FIGS. 12A and 12B are diagrams that illustrate an example in a case when it is difficult to recognize a stereoscopic image according to the size of the display;

FIG. 13 is a diagram for describing an example of a calculation method of the enlargement factor;

FIG. 14 is a flowchart for describing a first size adjustment process that the television set of FIG. 1 performs;

FIG. 15 is a block diagram that illustrates another configuration example of the television set of the embodiments of the present disclosure;

FIGS. 16A to 16F are diagrams that illustrate an outline of the processes that the television set of FIG. 15 performs;

FIG. 17 is a first diagram for describing a calculation method of the interocular distance and the viewing distance;

FIG. 18 is a second diagram for describing a calculation method of the interocular distance and the viewing distance;

FIG. 19 is a flowchart for describing a second size adjustment process that the television set of FIG. 15 performs; and

FIG. 20 is a block diagram that illustrates a configuration example of a computer.

### DETAILED DESCRIPTION OF EMBODIMENTS

The embodiments of the present disclosure (hereinafter, referred to as the embodiments) will be described below. Here, description will be given in the following order.

1. First Embodiment (example in a case when a three-dimensional image is viewed while wearing 3D glasses)
2. Second Embodiment (example in a case when a three-dimensional image is viewed with the naked eye)

### 3. Modified Examples

### 1. First Embodiment

### Configuration Example of Television Set 21

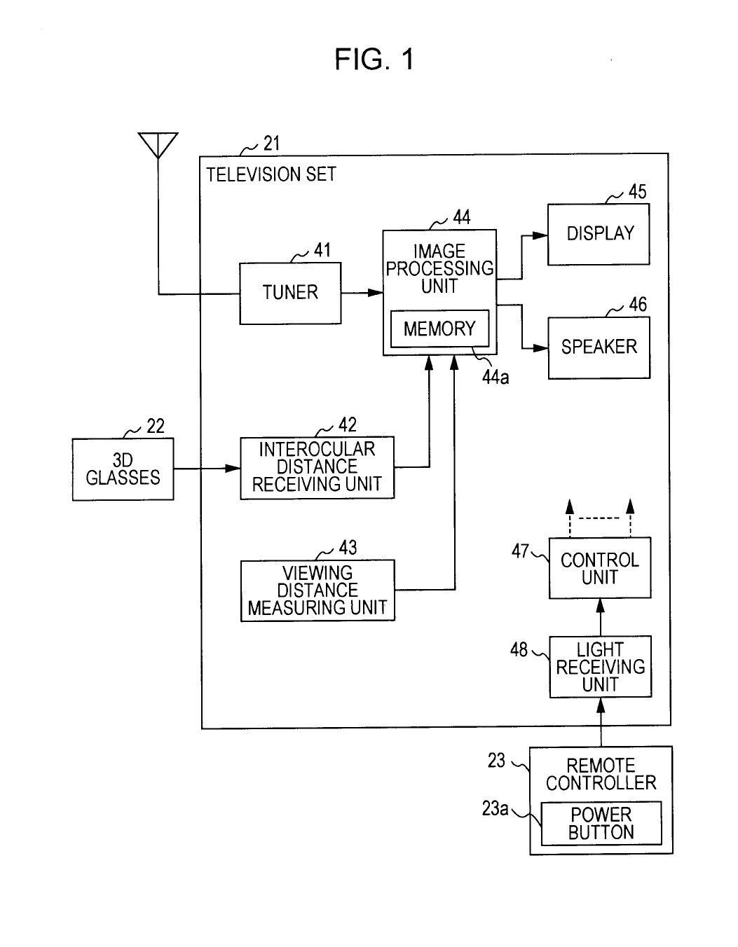

FIG. 1 illustrates a configuration example of a television set 21 to which the technique of the embodiments of the present disclosure is applied.

Here, the television set 21 allows content as a three-dimensional image to be viewed in a viewing environment according to, for example, an interocular distance that indicates the distance between the left and right pupils of the user that wears 3D glasses 22.

Specifically, for example, the television set 21 allows the user to view the content at a recommended distance that represents the distance that is recommended according to the interocular distance of the user by guiding the user.

Further, for example, the television set 21 acts according to operation signals from a remote controller 23. Other than a turning button that is used for tuning and the like, the remote controller 23 includes a power button 23a for turning the power of the television set 21 ON or OFF.

The television set 21 is configured by a tuner 41, an interocular distance receiving unit 42, a viewing distance measuring unit 43, an image processing unit 44 with a memory 44a built in, a display 45, a speaker 46, a control unit 47, and a light receiving unit 48.

The tuner 41 tunes and demodulates a broadcast signal that corresponds to a predetermined channel (frequency) from among a plurality of broadcast signals that are received via an antenna that is connected, and supplies the broadcast signal to the image processing unit 44.

The interocular distance receiving unit 42 receives the interocular distance (information representing the interocular distance) from the 3D glasses 22 and supplies the interocular distance to the image processing unit 44.

The viewing distance measuring unit 43 measures (calculates) the viewing distance that represents the distance to the user when viewing content and supplies the viewing distance to the image processing unit 44. Specifically, for example, the viewing distance measuring unit 43 measures the viewing distance based on the time elapsed between emitting ultrasounds to the user and receiving the ultrasounds from the user and the speed of the ultrasounds, and supplies the viewing distance to the image processing unit 44.

Here, the method of measuring the viewing distance which the viewing distance measuring unit 43 performs is not limited to a measurement method using ultrasounds, and for example, a measurement may be made by a stereo camera that measures the viewing distance based on the parallax between two difference cameras.

The image processing unit 44 separates the broadcast signals from the tuner 41 into image signals and sound signals and causes corresponding images to be displayed by supplying the separated image signals to the display 45 and causes the corresponding sounds to be output by supplying the separated sound signals to the speaker 46.

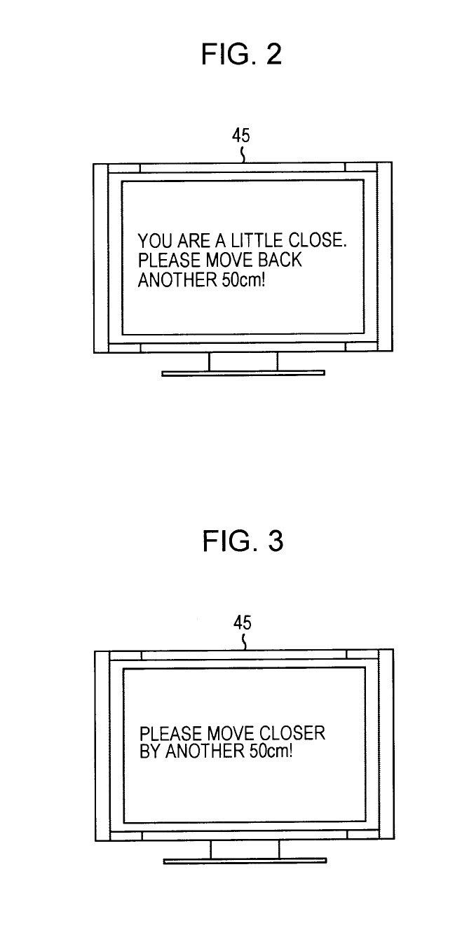

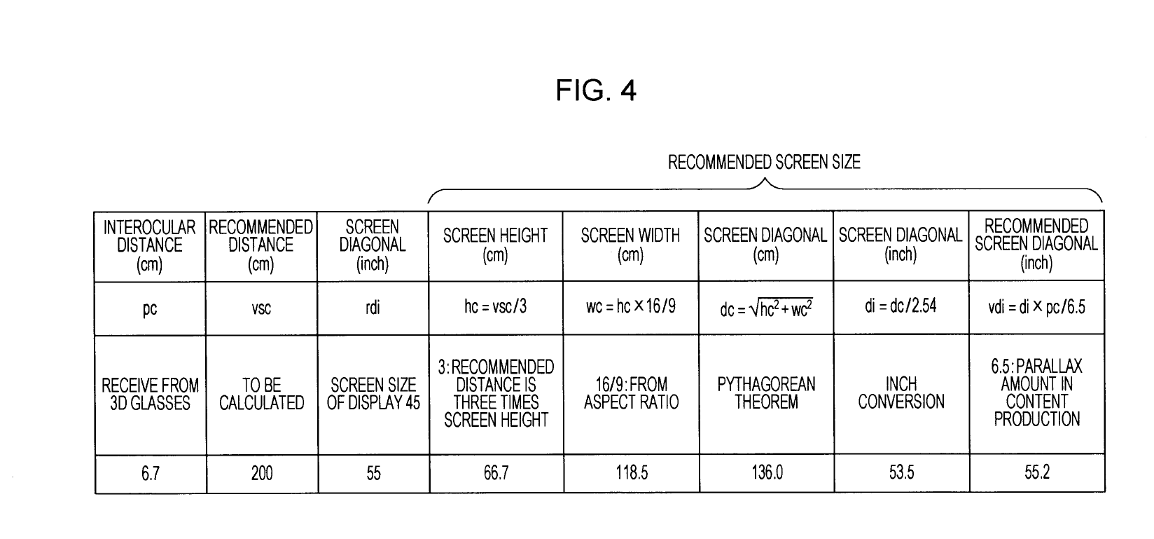

Further, the image processing unit 44 calculates the viewing distance that is recommended when viewing content based on the interocular distance from the interocular distance receiving unit 42, the screen diagonal that represents the size of the screen of the display 45 which is retained in the memory 44a in advance, and the like as the recommended distance. Furthermore, as illustrated in FIGS. 2 and 3, the image processing unit 44 causes a message that guides the user to a position where it is possible to view the content at the recommended distance to be displayed on the display 45. Here, the method of the calculation of the recommended distance which the image processing unit 44 performs will be described later with reference to FIG. 4.

The display 45 displays an image that corresponds to an image signal from the image processing unit 44.

The speaker 46 outputs a sound that corresponds to a sound signal from the image processing unit 44.

The control unit 47 controls the tuner 41, the interocular distance receiving unit 42, the viewing distance measuring unit 43, and the image processing unit 44 based on operation signals from the light receiving unit 48, for example.

The light receiving unit 48 receives an operation signal from the remote controller 23 and supplies the operation signal to the control unit 47.

### [Calculation Method of Recommended Distance]

Next, FIG. 4 illustrates an example of a calculation method of the image processing unit 44 calculating the recommended distance.

The first row of FIG. 4 shows, in order from the left, the interocular distance pc (cm) of the user, the recommended distance vsc (cm), the screen diagonal rdi (inch) that represents the actual length of the diagonal line across the screen of the display 45, and the recommended size of the screen which represents the screen of the display 45 which is recommended when the user views content.

As the recommended size of the screen, the screen height hc=vsc/3 (cm) that represents the recommended height of the screen, the screen width wc=hc×16/9 (cm) that represents the recommended width of the screen, the screen diagonal dc=√(hc²+wc²) (cm) that represents the length of the recommended diagonal line across the screen, the screen diagonal di=dc/2.54 (inch) that is obtained by converting the screen diagonal dc into inches, and a recommended screen diagonal vdi=di×pc/6.5 (inch) of the screen in a case when the parallax amount that is provided for the content is 6.5 cm are shown.

The image processing unit 44 calculates the recommended distance vsc based on the interocular distance pc from the interocular distance receiving unit 42 and the screen diagonal rdi of the display 45 which is stored in advance in the in-built memory 44a. Here, the interocular distance pc and the screen diagonal rdi are known quantities, and the recommended distance vsc is an unknown quantity (variable).

That is, for example, the image processing unit 44 calculates the screen height hc=vsc/3 based on the recommended distance vsc that is a variable, and calculates the screen width wc=hc×16/9 from the aspect ratio of the screen based on the calculated screen height hc. Furthermore, the image processing unit 44 calculates the screen diagonal dc=√(hc²+wc²) by the Pythagorean theorem based on the calculated screen height hc and the screen width we and calculates the screen diagonal di=dc/2.54 that is obtained by converting the calculated screen diagonal dc=√(hc²+wc²) into inches.

The image processing unit 44 calculates the recommended screen diagonal vdi=di×pc/6.5 based on the calculated screen diagonal di, the interocular distance pc from the interocular distance receiving unit 42, and the parallax amount 6.5 cm that is retained in advance in the memory 44a.

Here, if the screen diagonal di is represented by the recommended distance vsc that is a variable, the screen diagonal di=√{(vsc/3)²+(vsc×16/27)²}/2.54. Therefore, the recommended screen diagonal vdi=√{(vsc/3)²+(vsc×16/27)²}/2.54×pc/6.5. Here, since the interocular distance pc is a known quantity, the recommended screen diagonal vdi is represents by a function f(vsc) with the recommended vsc as the variable.

Therefore, the recommended screen diagonal vdi=f(vsc) and vsc in which vdi=f(vsc)=rdi is satisfied becomes the recommended distance when viewing content as a three-dimensional image with the screen diagonal rdi of the display 45.

Specifically, for example, as illustrated in FIG. 4, in a case when pc=6.7 and rdi=55, f(vsc)=rdi is f(vsc)=√{(vsc/3)²+(vsc×16/27)²}/2.54×6.7/6.5=55. Therefore, the image processing unit 44 calculates the recommended distance vsc=200 by solving f(vsc) through vsc.

Therefore, the image processing unit 44 calculates the recommended distance vsc by solving f(vsc)=rdi through the recommended distance vsc. Furthermore, the image processing unit 44 causes a message to guide the user to a viewable position with the calculated recommended distance vsc on the display 45 as illustrated in FIGS. 2 and 3.

### [Description of Actions of Television Set 21]

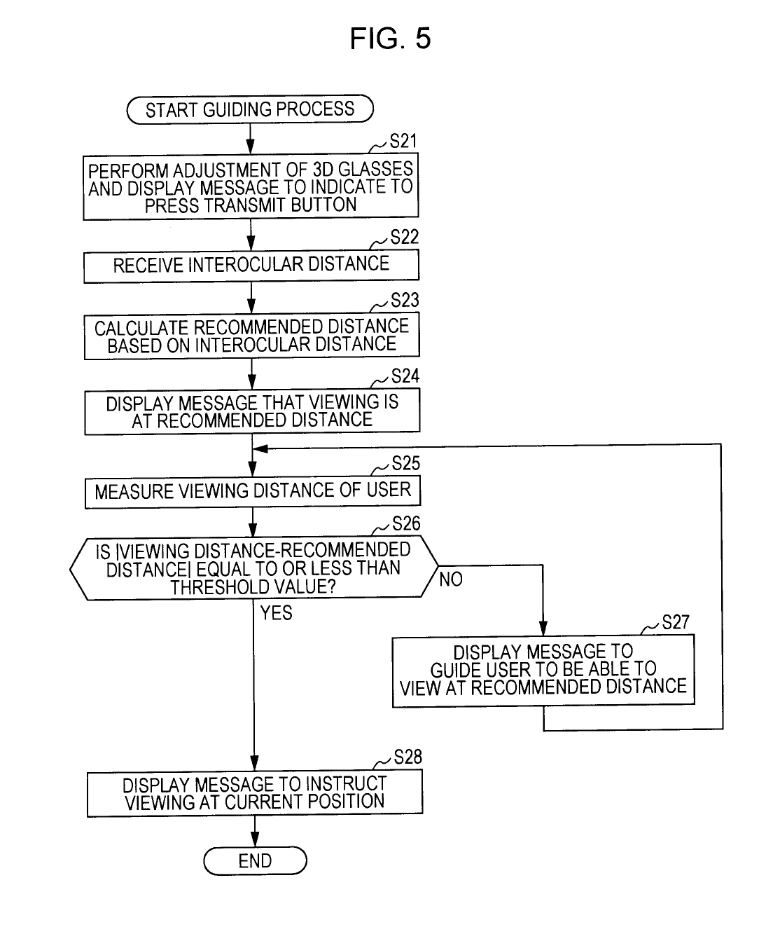

Next, the guiding process that the television set 21 performs will be described with reference to the flowchart of FIG. 5.

Such a guiding process is started, for example, when the user presses the power button 23a of the remote controller 23 in a case when the power of the television set 21 is OFF. At this time, a three-dimensional image as the content that is tuned and modulated by the tuner 41 and which is supplied via the image processing unit 44 is displayed on the display 45.

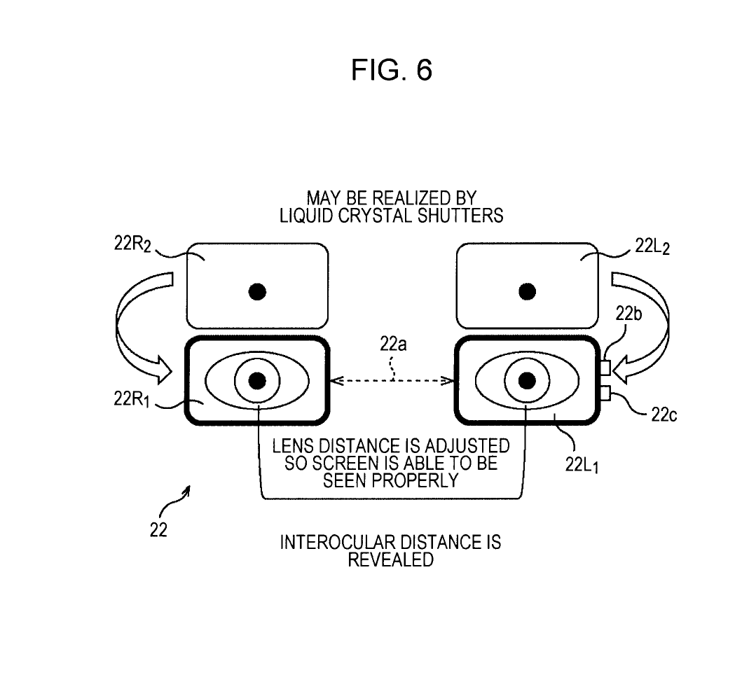

In step S21, the image processing unit 44 causes a message to wear the 3D glasses 22 and press a transmit button 22b (FIG. 6) to be displayed on the display 45 according to a control from the control 47. Such a message is displayed by being superimposed over a program that is being displaying on the display 45 by a picture-in-picture, for example.

The user sees the message that is displayed on the display 45 and puts on the 3D glasses 22. Furthermore, the user adjusts the 3D glasses 22 according to their own interocular distance and presses the transmit button 22b that is provided on the 3D glasses 22. In so doing, the 3D glasses 22 calculate (detect) and transmit the interocular distance pc of the user to the interocular distance receiving unit 42. Here, details of the 3D glasses 22 will be described in detail with reference to FIGS. 6 to 8.

In step S22, the interocular distance receiving unit 42 receives the interocular distance pc that is transmitted from the 3D glasses 22 and supplies the interocular distance pc to the image processing unit 44.

In step S23, the image processing unit 44 calculates the recommended distance vsc based on the interocular distance pc from the interocular distance receiving unit 42 and the screen diagonal rdi that is retained in the in-built memory 44a in advance. Furthermore, in step S24, the image processing unit 44 causes a message such as, for example, requesting to view the content at the recommended distance vsc as a message to guide the viewer to a position where it is possible to view the content by the calculated recommended distance vsc to be displayed on the display 45. Here, in addition to or instead of causing a message to be displayed on the display 45, the image process unit 44 may cause the message to be output as a sound from the speaker 46. The same also applies to other messages (for example, the messages illustrated in FIGS. 2, 3, and 9, or the like).

In step S25, the viewing distance measuring unit 43 measures and outputs the viewing distance sc of the user to the image processing unit 44.

In step S26, the image processing unit 44 calculates the viewing distance sc from the viewing distance measuring unit 43 and the absolute difference |sc−vsc| with the calculated recommended distance vsc. Furthermore, the image processing unit 44 determines whether or not the user is at a position where it is possible to view the content at the recommended distance based on whether or not the calculated absolute difference |sc−vsc| is equal to or less than a threshold value determined in advance.

In step S26, in a case when the image processing unit 44 determines that the user is not at a position where it is possible to view the content at the recommended distance vsc since the absolute difference |sc−vsc| is not equal to or less than the threshold value, the process proceeds to step S27.

In step S27, the image processing unit 44 causes a message to guide the user to a position where it is possible to view the content at the recommended distance vsc to be displayed on the display 45 based on the difference (sc−vsc) that is obtained by subtracting the recommended distance vsc from the viewing distance sc.

That is, for example, in a case when the difference (sc−vsc) is negative, that is, in a case when the user is at a position that is closer to the display 45 by the absolute value |sc−vsc| than the recommended distance vsc, the image processing unit 44 causes a message to request moving away from the display 45 by the absolute difference |sc−vsc| to be displayed. Specifically, for example, in a case when the difference (sc−vsc) is −50 cm, the message “You are a little close. Please move back another 50 cm!” as illustrated in FIG. 2 is displayed on the display 45.

Further, for example, in a case when the difference (sc−vsc) is positive, that is, in a case when the user is at a position that is further from the display 45 by the absolute value |sc−vsc| than the recommended distance vsc, the image processing unit 44 causes a message to request approaching the display 45 by the absolute difference |sc−vsc| to be displayed. Specifically, for example, in a case when the difference (sc−vsc) is 50 cm, the message “Please move close by another 50 cm!” as illustrated in FIG. 3 is displayed on the display 45.

Furthermore, the process is returned from step S27 to step S25, and the same processes are thereafter repeated.

Further, in step S26, in a case when the image processing unit 44 determines that the user is (almost) at a position where it is possible to view the content at the recommended distance vsc since the absolute difference |sc−vsc| is equal to or less than the threshold value, the process proceeds to step S28.

In step S28, the image processing unit 44 causes a message prompting the view the content at the current position to be displayed on the display 45. The guiding process is then ended.

As described above, in the guiding process, the content is viewed at the recommended distance by guiding the user. Therefore, it becomes possible, for example, to view content as a three-dimensional image with the stereoscopic effect that the creator of the content intended.

Accordingly, since the user does not view the content as a three-dimensional image or the like in which the stereoscopic effect is excessively emphasized, it is possible to view the content without experiencing discomfort.

Furthermore, since the creator of content is not obliged to consider the viewing environment of the user, it becomes possible to create three-dimensional images with the same parallax for any content, thus saving effort when creating the content.

That is, it is possible, for example, to save the effort of having to provide different content for children (for example, children whose interocular distances are approximately 5 cm) and content for adults (for example, adults whose interocular distances are approximately 6.5 cm).

Further, for example, the creator of the content is relieved of the effort of creating content for children by performing a process of suppressing the stereoscopic effect of three-dimensional images on content for which a relatively large parallax is provided.

### [Regarding 3D Glasses 22]

Next, FIG. 6 illustrates an outline of the 3D glasses 22.

Here, the 3D glasses 22 are worn by the user so that it is possible to recognize a three-dimensional image that is displayed on the display 45 as content as a stereoscopic image. Here, a three-dimensional image is configured by a left eye two-dimensional image and a right eye two-dimensional image, and a parallax is provided between the left eye two-dimensional image and the right eye two-dimensional image so that an object in an image that the user sees appears stereoscopically.

The 3D glasses 22 causes the user to see a three-dimensional image as a stereoscopic image by presenting the left eye two-dimensional image to be seen by only the left eye of the user and presenting the right eye two-dimensional image to be seen by only the right eye of the user.

Further, the 3D glasses 22 are mainly configured by a right eye shutter 22R₁, a left eye shutter 22L₁. A right eye panel 22R₂, a left eye panel 22L₂, a movable bridge 22a, the transmit button 22b, and an interocular distance transmission unit 22c.

The right eye shutter 22R₁ is arranged in front of the right eye of the user when the user wears the 3D glasses 22. Similarly, the left eye shutter 22L₁ is arranged in front of the left eye of the user when the user wears the 3D glasses 22.

The right eye shutter 22R₁ and the left eye shutter 22L₁ alternately block the fields of view of the right eye and the left eye by a shutter or the like to cause the user to see the right eye two-dimensional image and the left eye two-dimensional image that are alternately displayed on the display 45 as a stereoscopic image. Here, the right eye shutter 22R₁ and the left eye shutter 22L₁ are alternately driven according to, for example, a control signal from the television set 21.

That is, the blocking of the field of view by the right eye shutter 22R₁ is released and blocking of the field of view by the left eye shutter 22L₁ is performed when the right eye two-dimensional image is displayed on the display 45. Further, blocking of the field of view by the right eye shutter 22R₁ is performed and the blocking of the field of view by the left eye shutter 22L₁ is released when the left eye two-dimensional image is displayed on the display 45.

Here, with the right eye shutter 22R₁ and the left eye shutter 22L₁, if the timing at which the blocking is released is changed for each user, it becomes for each user to view respectively different content using only one display 45.

That is, for example, in a case when a first user views content A and a second user views content B, synchronizing with display timings t1, t2, t3, t4, . . . , for example, the display 45 displays the left eye two-dimensional image of the content A at the display timing t1, the left eye two-dimensional image of the content B at the display timing t2, the right eye two-dimensional image of the content A at the display timing t3, and the right eye two-dimensional image of the content B at the display timing t4, . . . in such an order.

Synchronizing with the display timings t1, t3, . . . , for example, the 3D glasses 22 worn by the first user release only the blocking of the field of view by the left eye shutter 22L₁ at the display timing t1 and release only the blocking of the field of view by the right eye shutter 22R₁ at the display timing t3. Further, synchronizing with the other display timings t2, t4, . . . , the 3D glasses 22 worn by the first user maintain the blocking of the field of view by the left eye shutter 22L₁ and the right eye shutter 22R₁.

Furthermore, synchronizing with the display timings t2, t4, . . . , for example, the 3D glasses 22 worn by the second user release only the blocking of the field of view by the left eye shutter 22L₁ at the display timing t2 and release only the blocking of the field of view by the right eye shutter 22R₁ at the display timing t4. Further, synchronizing with the other display timings t1, t3, . . . , the 3D glasses 22 worn by the second user maintain the blocking of the field of view by the left eye shutter 22L₁ and the right eye shutter 22R₁.

In a case when causing the first and second users to view content at fixed frame rates in such a manner, the frame rate of each image that is displayed on the display 45 (the respective left eye two-dimensional image and the right eye two-dimensional image of the content A and the content B) is higher when there are more users.

The right eye panel 22R₂ and the left eye panel 22L₂ are respectively moved in front of the right eye shutter 22R₁ and the left eye shutter 22L₁ when the distance between the right eye shutter 22R₁ and the left eye shutter 22L₁ is adjusted by the user.

A small peephole (illustrated by a black dot in the drawings) is respectively provided on the right eye panel 22R₂ and the left eye panel 22L₂.

Therefore, the user adjusts the distance between the right eye shutter 22R₁ and the left eye shutter 22L₁ to a position where the display 45 is able to be seen properly through the peephole that is respectively provided on the right eye panel 22R₂ and the left eye panel 22L₂. Such an adjustment is performed, for example, manually or automatically. Further, the blocking of the right eye shutter 22R₁ and the left eye shutter 22L₁ are both released.

Here, when adjusting the distance between the right eye shutter 22R₁ and the left eye shutter 22L₁, the right eye panel 22R₂ and the left eye panel 22L₂ are made redundant in the 3D glasses 22 if a small peephole is provided in the center of the right eye shutter 22R₁ and the left eye shutter 22L₁ so that the fields of view with the exception of the central portions are blocked.

The movable bridge 22a is a bridge that connects the right eye shutter 22R₁ and the left eye shutter 22L₁, and is able to expand and contract in the left and right directions in the drawings according to the distance between the right eye shutter 22R₁ and the left eye shutter 22L₁. When the movable bridge expands or contracts, the movable bridge 22a detects a bridge length that represents the length of the movable bridge and supplies the bridge length to the interocular distance transmission unit 22c.

The transmit button 22b is pressed, for example, after the distance between the right eye shutter 22R₁ and the left eye shutter 22L₁ is adjusted, and a control signal that corresponds to the pressing is supplied to the interocular distance transmission unit 22c.

The interocular distance transmission unit 22c measures the interocular distance based on the bridge length from the movable bridge 22a. Furthermore, when the operation signal from the transmit button 22b is received, the interocular distance transmission unit 22c transmits the measured interocular distance to the television set 21.

Here, although the interocular distance transmission unit 22c measures the interocular distance based on the bridge length from the movable bridge 22a, the measurement method of measuring the interocular distance in the 3D glasses 22 is not limited thereto.

That is, for example, as a measurement method, it is possible to measure the interocular distance by using an eye tracking technique or the like of tracking the left and right pupils of the user in the 3D glasses 22.

### [Configuration Example of 3D Glasses 22]

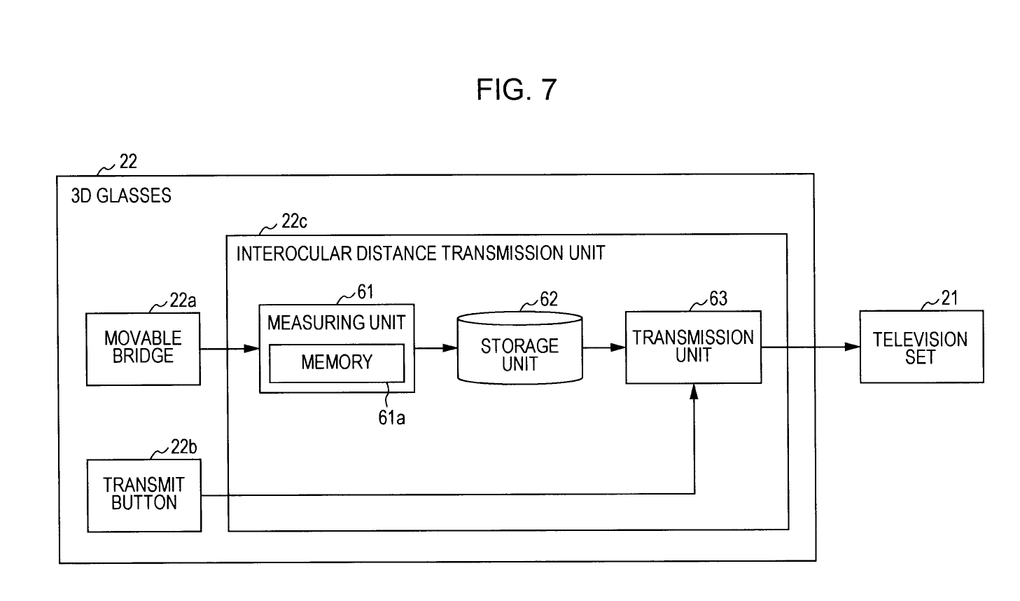

Next, FIG. 7 illustrates a configuration example of the 3D glasses 22.

The 3D glasses 22 is mainly configured by the movable bridge 22a, the transmit button 22b, and the interocular distance transmission unit 22c. Here, in order to avoid complicating the drawing, the right eye shutter 22R₁, the left eye shutter 22L₁, the right eye panel 22R₂, and the left eye panel 22L₂ are omitted from the drawing.

Further, since the movable bridge 22a and the transmit button 22b have been described with reference to FIG. 6, the descriptions thereof are omitted as appropriate.

The interocular distance transmission unit 22c is configured by a measuring unit 61, a storage unit 62, and a transmission unit 63.

The measuring unit 61 has a memory 61a built in. The memory 61a retains a table in which corresponding interocular distances are associated with different bridge lengths in advance. The measuring unit 61 measures (detects) the corresponding interocular distance by referring to the table retained in the built-in memory 61a based on the bridge length from the movable bridge 22a, supplies the interocular distance to the storage unit 62 and causes the interocular distance to be stored by overwriting.

Further, by causing the memory 61a to retain an offset value in advance, the measuring unit 61 may add an offset value that is stored in the memory 61a to the bridge length from the movable bridge 22a and measure the addition result as the interocular distance. Here, the offset value represents a positive value that is obtained by subtracting the bridge length from the interocular distance (distance between the peephole provided on the right eye panel 22R₂ and the peephole provided on the left eye panel 22L₂).

The storage unit 62 stores the interocular distance from the measuring unit 61.

The transmission unit 63 receives an operation signal from the transmit button 22b and reads the interocular distance that is stored in the storage unit 62. Furthermore, the transmission unit 63 transmits the read interocular distance to the television set 21 using a wireless communication system such as IrDA (Infrared Data Association), Bluetooth (registered trademark), or wireless USB (Universal Serial Bus).

Here, the 3D glasses 22 may measure the viewing distance by providing a similar range sensor to the viewing distance measuring unit 43 of the television set 21. In such a case, the transmission unit 63 also transmits the viewing distance that is measure to the television set 21, making the viewing distance measuring unit 43 redundant in the television set 21.

Further, for example, since the configuration of the 3D glasses 22 is simplified by providing a range sensor on the remote controller 23 instead of on the 3D glasses 22, compared to a case when a range sensor is provided on the 3D glasses 22, the user does not feel disturbed.

### [Description of Actions of 3D Glasses 22]

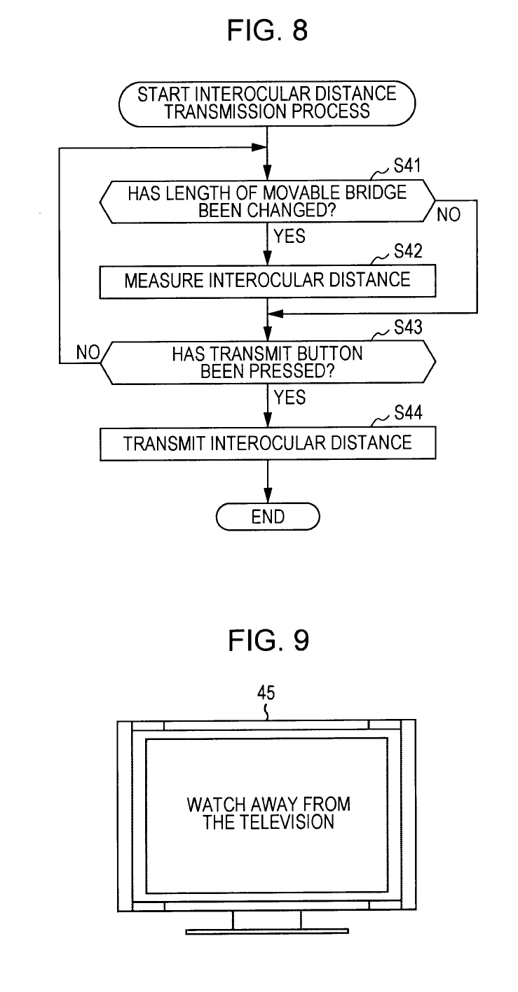

Next, the interocular distance transmission process that the 3D glasses 22 perform will be described with reference to the flowchart of FIG. 8.

In step S41, the movable bridge 22a determines whether or not the bridge length of the movable bridge 22a has been changed the distance between the right eye shutter 22R₁ and the left eye shutter 22L₁ being adjusted.

In a case when it is determined that the bridge length of the movable bridge 22a is changed, the movable bridge 22a detects the bridge length and supplies the bridge length to the measuring unit 61, and the process proceeds to step S42.

In step S42, the measuring unit 61 measures (obtains) the interocular distance that corresponds to the bridge length from the movable bridge 22a by referencing the table that is retained in the built-in memory 61a, supplies the interocular distance to the storage unit 62, and causes the interocular distance to be stored by overwriting, and the process proceeds to step S43.

Here, in step S41, in a case when it is determined that the bridge length of the movable bridge 22a has not been changed, the movable bridge 22a skips step S42 and the process proceeds to step S43.

In step S43, the transmission unit 63 determines whether or not the transmit button 22b has been pressed by the user based on whether or not an operation signal from the transmit button 22b has been supplied. Furthermore, in a case when the transmission unit 63 determines that the transmit button 22b has not been pressed by the user based on whether or not an operation signal from the transmit button 22b has been supplied, the process is returned to step S41 and the same processes thereafter are repeated.

Further, in step S43, in a case when the transmission button 63 determines that the transmit button 22b has been pressed by the user based on whether or not a control signal from the transmit button 22b has been received, the interocular distance that is stored in the storage unit 62 is read from the storage unit 62. Furthermore, the transmission unit 63 transmits the read interocular distance to the television set 21 using a wireless communication system such as IrDA, Bluetooth (registered trademark), or wireless USB. The interocular distance transmission process is then ended.

As described above, in the interocular distance transmission process, the interocular distance of the user is transmitted to the television set 21. Therefore, with the television set 21, it becomes possible to guide the user to a position where it is possible to view the content at a recommended distance according to the interocular distance of the user.

Although in the first embodiment, the image processing unit 44 calculates the recommended distance vsc based on the interocular distance pc and the screen diagonal rdi and guides the user to a position where it is possible to view the content at the recommended distance vsc that is calculated, the processes that the image processing unit 44 perform are not limited thereto.

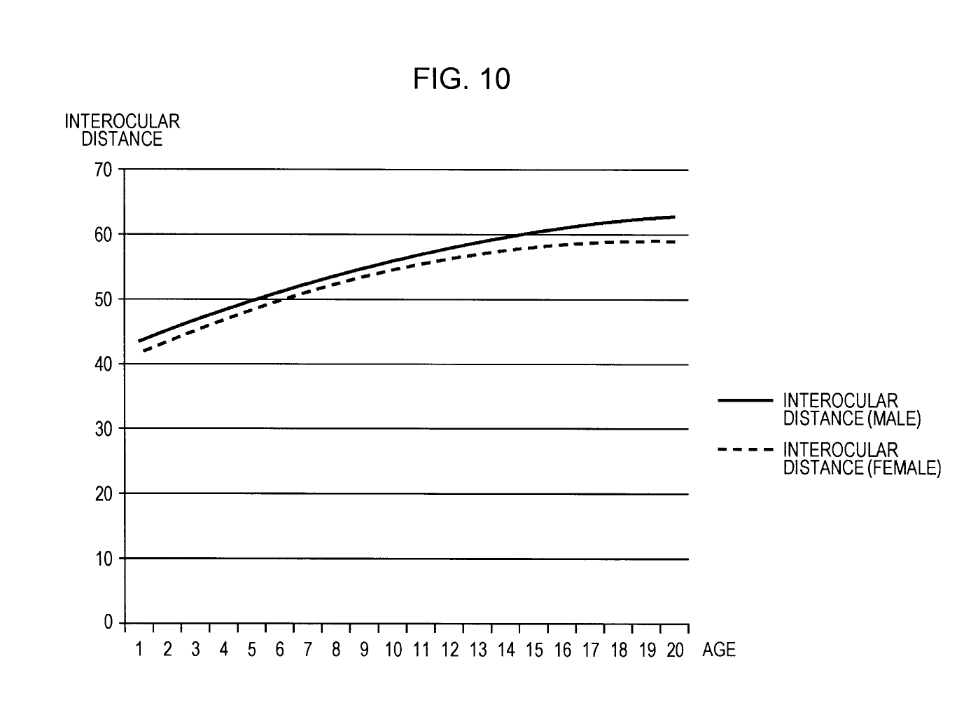

That is, for example, the image processing unit 44 determines the age of the user based on the interocular distance pc from the interocular distance receiving unit 42. Furthermore, in a case when the determined age of the user is less than a predetermined age (for example, 12 years old), the image processing unit 44 may display the message “watch away from the television” illustrated in FIG. 9 on the display 45 before display the content. Here, it is generally accepted that there is a relationship between the interocular distance and age as illustrated in FIG. 10.

Further, for example, the image processing unit 44 may determine whether or not the viewing distance from the viewing distance measuring unit 43 is less than a predetermined threshold value and display the message illustrated in FIG. 9 on the display 45 until it is determined that the viewing distance is not less than the predetermined threshold value. In such a case, since the content is not displayed until the user moves away from the television set 21, it is possible to more certainly prevent a situation in which the content is viewed close to the television set 21.

Furthermore, for example, in a case when it is determined that the age of the user is less than a predetermined age, the image processing unit 44 may prevent the display of harmful content for users under the predetermined age (for example, content with expressions of violence or the like) on the display 45.

Here, in a case when the user is less than a predetermined age, the message as illustrated in FIG. 9 is displayed on the display 45 because the lower the age of the user, the stronger the stereoscopic effect by the three-dimensional image which is felt.

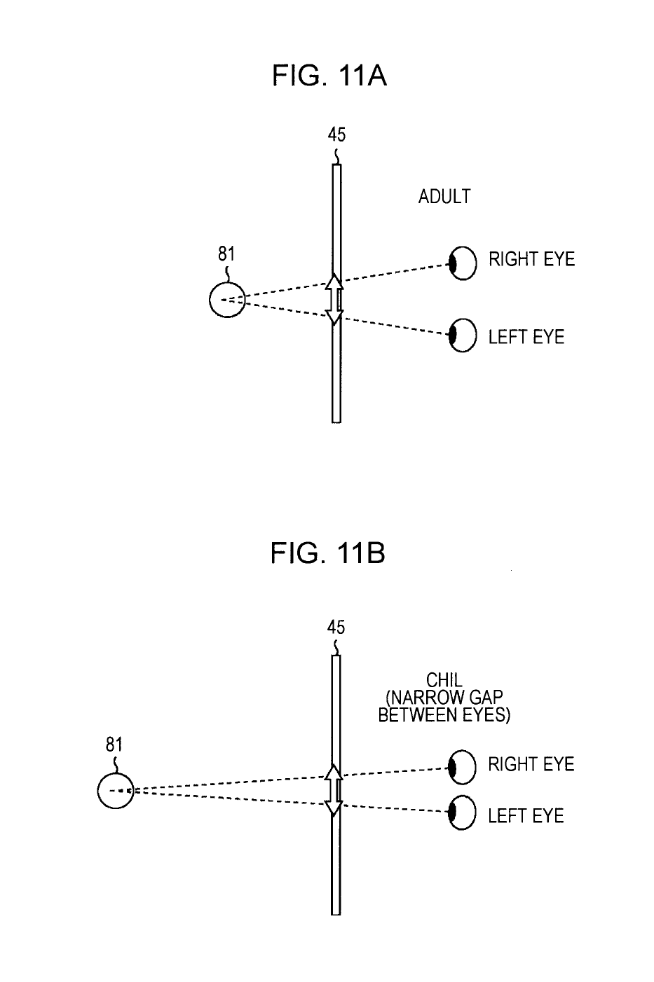

Next, FIGS. 11A and 11B illustrate how the lower the age of the user, the stronger the stereoscopic effect by the three-dimensional image which is felt.

FIG. 11A illustrates an example in a case when a target 81 that is displayed on the display 45 appears to be in the depth direction (left in the drawing) of the display 45 in a case when the user is an adult.

FIG. 11B illustrates an example in a case when the target 81 that is displayed on the display 45 appears to be in the depth direction (left in the drawing) of the display 45 in a case when the user is a child.

As illustrated in FIGS. 11A and 11B, even with three-dimensional images in which the same parallax is provided between the right eye two-dimensional image and the left eye two-dimensional image, the manner in which the target 81 is seen differs according to the interocular distance of the user. In particular, for example, in a case when the user is a child (in a case when the interocular distance is small), the sense of depth of the target 81 which the user perceives becomes stronger as compared to a case when the user is an adult (in a case when the interocular distance is large).

Therefore, the television set 21 is able to display the message illustrated in FIG. 9 on the display 45 in order to prevent a situation in which there is a detrimental effect on health by a child perceiving the sense of depth too strongly.

Incidentally, as described with reference to the flowchart of FIG. 5, the television set 21 causes the user to view the content at the recommended distance by guiding the user.

However, in a case when the television set 21 is placed in a comparatively small room, it may be difficult for the user to view the content at the recommended distance.

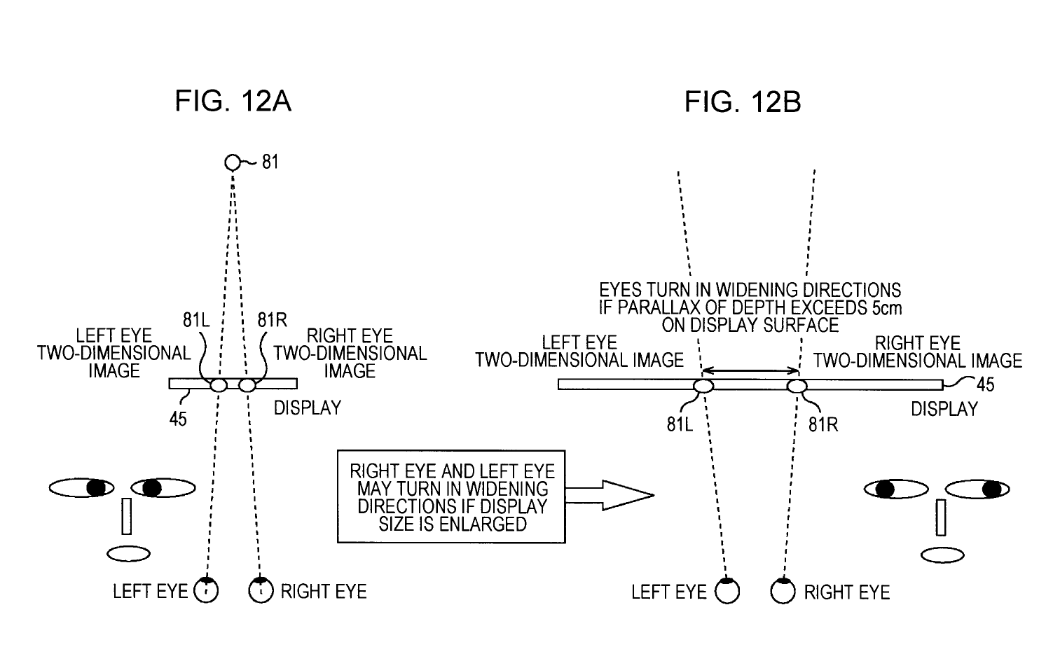

That is, for example, in a case when the display 45 is small, the recommended distance becomes short. In such a case, since the user is able to view the content at the recommended distance even in a small room, as illustrated in FIG. 12A, it is possible to see the target 81 stereoscopically. Here, in FIGS. 12A and 12B, a target display 81L represents the target 81 that is displayed on the left eye two-dimensional image, and a target display 81R represents the target 81 that is displayed on the right eye two-dimensional image.

On the other hand, in a case when the display 45 is large, the recommended distance is long. Therefore, it is difficult for the user to secure the viewing distance sufficiently in a small room, and the content is viewed at less than the recommended distance. In such a case, the lines of sight of the left and right eyes of the user head outward as illustrated in FIG. 12B, and it is difficult for the user to see the three-dimensional image on the display 45 stereoscopically.

Therefore, it is desirable that the screen diagonal rdi of the display 45 of the television set 21 be adjusted to the recommended screen diagonal vdi of the recommended screen that is recommended according to the interocular distance pc and the viewing distance sc.

Here, in reality, the screen diagonal rdi of the display 45 is fixed and is not adjustable. Therefore, the television set 21 adjusts the size of a three-dimensional image that is displayed on the display 45 to the most appropriate screen size that is recommended according to the viewing distance sc and the interocular distance pc of the user.

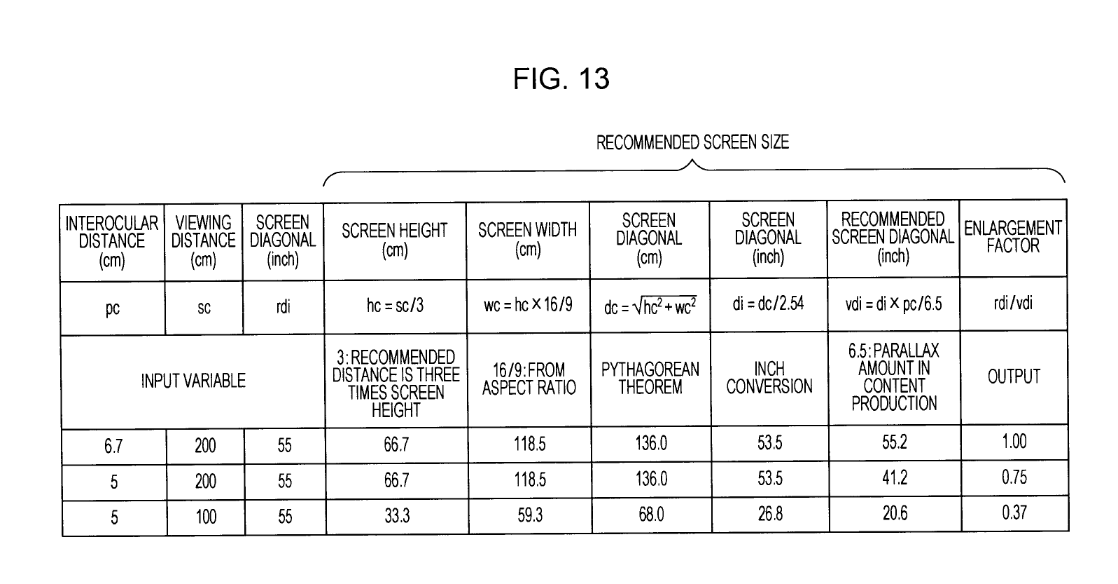

Next, FIG. 13 describes a first size adjustment process in which the image processing unit 44 causes the three-dimensional image to be displayed on the display 45 by adjusting the size of the three-dimensional image that is displayed on the display 45 to the most appropriate screen size that is recommended according to the viewing distance sc and the interocular distance pc of the user.

Here, other than the fact that the viewing distance sc is given instead of the recommended distance of FIG. 2 and an enlargement factor rdi/vdi is newly given, FIG. 13 is configured similarly to FIG. 2.

That is, the first row of FIG. 13 shows, in order from the left, the interocular distance pc (cm) of the user, the viewing distance sc (cm), the screen diagonal rdi (inch) of the display 45, the recommended size of the screen, and the enlargement factor rdi.

As the recommended size of the screen, the screen height hc=sc/3 (cm), the screen width wc=hc×16/9 (cm), the screen diagonal dc=√(hc²+wc²) (cm), the screen diagonal di=dc/2.54 (inch), and a recommended screen diagonal vdi=di×pc/6.5 (inch) are shown.

The image processing unit 44 calculates the enlargement factor rdi/vdi based on the interocular distance pc from the interocular distance receiving unit 42, the viewing distance sc from the viewing distance measuring unit 43, and the screen diagonal rdi of the display 45 which is retained in the in-built memory 44a in advance.

That is, for example, the image processing unit 44 calculates the screen height hc=sc/3 based on the viewing distance sc from the viewing distance measuring unit 43, and calculates the screen width wc=hc×16/9 based on the calculated screen height hc. Furthermore, the image processing unit 44 calculates the screen diagonal dc=√(hc²+wc²) based on the calculated screen height hc and the screen width we and calculates the screen diagonal di=dc/2.54 that is obtained by converting the unit of the screen diagonal into inches based on the calculated screen diagonal dc=√(hc²+wc²) into inches.

Further, the image processing unit 44 calculates the recommended screen diagonal rdi=di×pc/6.5 based on the calculated screen diagonal di, the interocular distance pc from the interocular distance receiving unit 42, and the parallax 6.5 that is retained in the memory 44a in advance. Here, the parallax 6.5 represents the parallax that is provided between the left eye two-dimensional image and the right eye two-dimensional image when creating a three-dimensional image.

Furthermore, the image processing unit 44 calculates rdi/vdi as the enlargement factor based on the screen diagonal rdi of the display 45 which is retained in advance in the in-built memory 44a and the recommended screen diagonal vdi.

The image processing unit 44 enlarges a three-dimensional image that corresponds to an image signal out of an image signal and a sound signal that are obtained by separating the broadcast signal from the tuner 41 by the enlargement factor rdi/vdi, supplies the three-dimensional image to the display 45 and causes the three-dimensional image to be displayed. That is, for example, the image processing unit 44 respectively enlarges the left eye two-dimensional image and the right eye two-dimensional image that configure the three-dimensional image by the enlargement factor rdi/vdi and causes the left eye two-dimensional image and the right eye two-dimensional image to be alternately displayed on the display 45.

Here, the image processing unit 44 supplies a sound signal that is obtained by being separated to the speaker 46 and causes a sound that corresponds to the sound signal to be output at a volume according to the viewing distance sc from the viewing distance measuring unit 43.

Specifically, for example, as illustrated in FIG. 13, in a case when pc=6.7, sc=200, and rdi=55, hc=66.7, wc=118.5, dc=136, di=53.5, vdi=55.2, and rdi/vdi≈1. In such a case, the image processing unit 44 supplies the three-dimensional image that corresponds to the image signal as is to the display 45 and causes the three-dimensional image to be displayed.

Further, for example, in a case when pc=5, sc=200, and rdi=55, hc=66.7, wc=118.5, dc=136, di=53.5, and vdi=41.2, and rdi/vdi≈0.75. In such a case, the image processing unit 44 enlarges the three-dimensional image that corresponds to the image signal by an enlargement factor rdi/vdi≈0.75 and supplies the three-dimensional image to the display 45 and causes the three-dimensional image to be displayed.

Furthermore, for example, in a case when pc=5, sc=100, and rdi=55, hc=33.3, wc=59.3, dc=68, di=26.8, and vdi=20.6, and rdi/vdi≈0.37. In such a case, the image processing unit 44 enlarges the three-dimensional image that corresponds to the image signal by an enlargement factor rdi/vdi≈0.37 and supplies the three-dimensional image to the display 45 and causes the three-dimensional image to be displayed.

### [Description of Other Actions of Television Set 21]

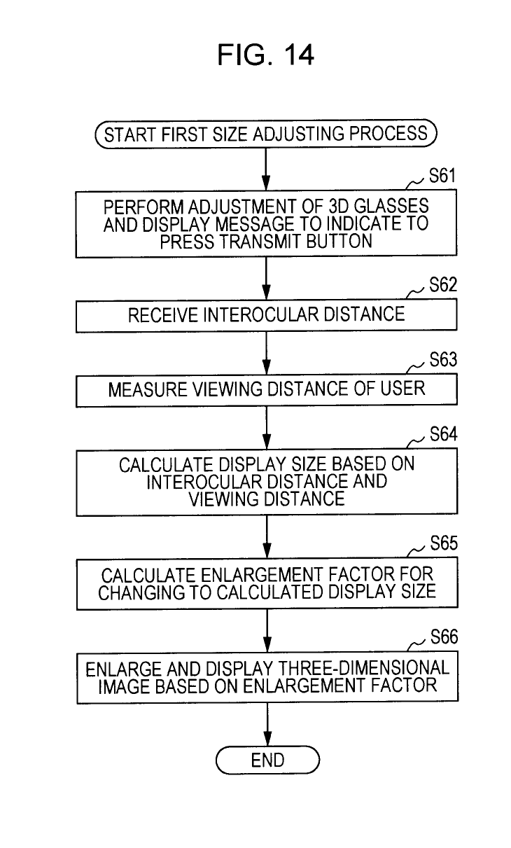

Next, the first size adjustment process that the television set 21 performs will be described with reference to the flowchart of FIG. 14.

The first size adjustment process is started, for example, in a case when the power of the television set 21 is OFF, when the user presses the power button 23a of the remote controller 23. At this time, a three-dimensional image as the content which is selected and modulated by the tuner 41 and which is supplied via the image processing unit 44 is displayed on the display 45.

The same processes as steps S21 and S22 of FIG. 5 are respectively performed in steps S61 and S62.

In step S63, the viewing distance measuring unit 43 measures the viewing distance sc of the user and supplies the viewing distance sc to the image processing unit 44.

In step S64, the image processing unit 44 calculates the recommended screen diagonal vdi based on the interocular distance pc from the interocular distance receiving unit 42 and the viewing distance sc from the viewing distance measuring unit 43.

In step S65, the image processing unit 44 calculates the enlargement factor rdi/vdi based on the calculated recommended screen diagonal vdi, and the screen diagonal rdi that is retained in the memory 44a in advance.

In step S66, the image processing unit 44 separates the broadcast signals from the tuner 41 into image signals and sound signals. Furthermore, the image processing unit 44 respectively enlarges the left eye two-dimensional image and the right eye two-dimensional image that correspond to the image signal that is obtaining by being separated by the enlargement factor rdi/vdi calculated in step S65. The image processing unit 44 supplies the enlarged left eye two-dimensional image and right eye two-dimensional image as an enlarged three-dimensional image to the display 45 and causes the enlarged three-dimensional image to be displayed.

Further, the image processing unit 44 outputs the sound that corresponds to the sound signal which is obtained by being separated at a volume according to the viewing distance sc from the viewing distance measuring unit 43 from the speaker 46. The first size adjustment process is then ended.

As described above, in the first size adjustment process, the size of the three-dimensional image that is displayed on the display 45 is changed to the recommended screen size according to the interocular distance of the user and the viewing distance. Therefore, in the first size adjustment process, even in a case when the viewing distance is not sufficiently long, for example, it is possible for the user to view the content with the stereoscopic effect that the creator of the content intended by only a simple process of changing the size of the three-dimensional image.

Further, in the first size adjustment process, since the size of the three-dimensional image that is displayed on the display 45 is changes to the recommended screen size according to the interocular distance of the user, the user is able to view the content at a preferred position.

Here, if the timing at which blocking is released by the right eye shutter 22R₁ and the left eye shutter 22L₁ of the 3D glasses 22 is changed for each user, it is possible to view a three-dimensional image as the content in a recommended screen size that is recommended to each user. Therefore, with the television set 21, it becomes possible for a plurality of users to view the content at the same time in viewing environments that are appropriate to each user.

Otherwise, for example, the image processing unit 44 may change the parallax of the three-dimensional image (parallax that is provided between the left eye two-dimensional image and the right eye two-dimensional image) instead of changing the size of the three-dimensional image.

That is, for example, the image processing unit 44 calculates a variable x when the parallax 6.5 of the recommended screen diagonal vdi=di×pc/6.5 illustrated in FIG. 13 is the variable x and the enlargement factor rdi/vdi=1. In such a case, since the interocular distance pc, the viewing distance sc, and the screen diagonal rdi are known quantities and the parallax x is a variable, rdi/vdi=1 is able to be expressed as a function g(x)=1 of the parallax x.

Therefore, the image processing unit 44 calculates the parallax x that is recommended for the three-dimensional image as the content that the user views by solving the function g(x)=1 by the parallax x that is a variable.

The image processing unit 44 changes the parallax of the three-dimensional image that corresponds to the image signal to the parallax x based on the calculated parallax x, and supplies the changed three-dimensional image to the display 45 and causes the three-dimensional image to be displayed. Therefore, for example, even in a case when the viewing distance is not sufficiently long, it is possible to view the content with the stereoscopic effect that the creator of the content intended and to view the content as the three-dimensional image in a size that the creator of the content intended.

### 2. Second Embodiment

### Configuration Example of Television Set 101

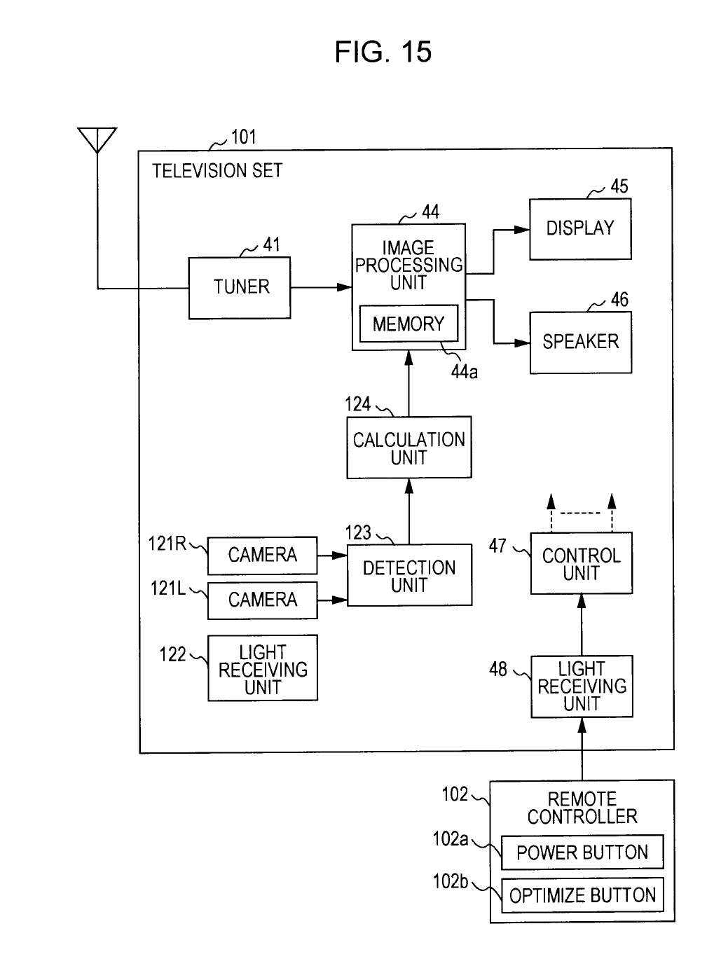

Next, FIG. 15 illustrates a configuration example of a television set 101 with which it is possible to view a three-dimensional image as a stereoscopic image without the user wearing the 3D glasses 22.

Here, the television set 101 allows a three-dimensional image to be seen as a stereoscopic image without the user wearing the 3D glasses 22 by adopting a parallax barrier system, a lenticular system, or the like.

Further, although the television set 101 greatly differs from the television set 21 in measuring the interocular distance of the user in the stead of the 3D glasses 22, for other processes, the same processes as the television set 21 are performed.

Accordingly, since in FIG. 15, the same symbols are given for portions that are configured similar to the television set 21 illustrated in FIG. 1, description thereof will be omitted as appropriate.

That is, the television set 101 is configured similarly to the television set 21 of FIG. 1 except that a camera 121R, a camera 121L, and a light emitting unit 122 are newly provided and a detection unit 123 and a calculation unit 124 are newly provided instead of the interocular distance receiving unit 42 and the viewing distance measuring unit 43 of FIG. 1.

Further, for example, other than a power button 101a that is controlled when the power of the television 101 is turned ON, a tuning button that is operated when tuning, or the like, an optimize button 102b that is operated when optimizing the size of the three-dimensional image that is displayed on the display 45 to the recommended screen size of the display 45 is provided on a remote controller 102.

The camera 121R and the camera 121L are respectively arranged on an upper portion of the display 45 with a fixed distance therebetween, and function as a stereo camera that detects the pupil positions that respectively represent the left and right pupils of the user. Here, the pupil positions are detected as three-dimensional positions.

The light emitting unit 122 emits light as a flash according to a control from the control unit 47 when detecting the pupil positions of the user.

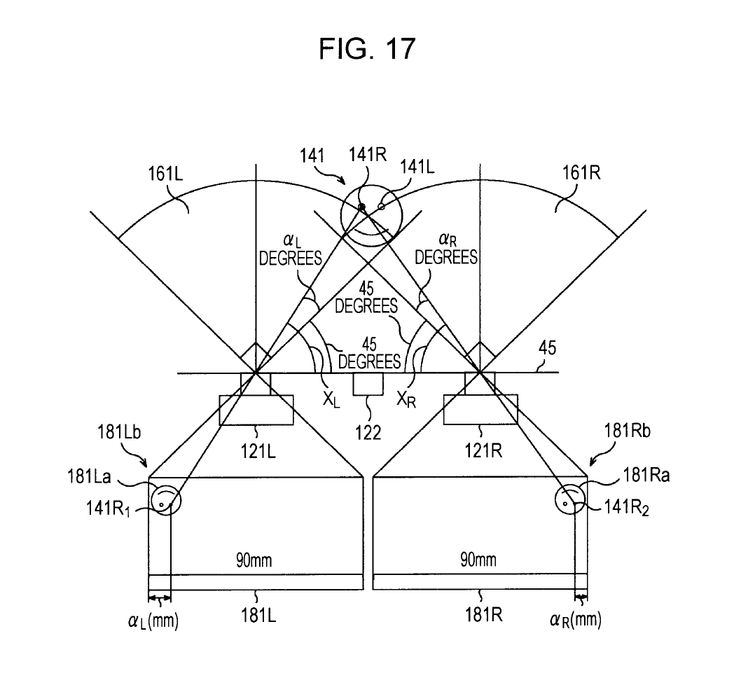

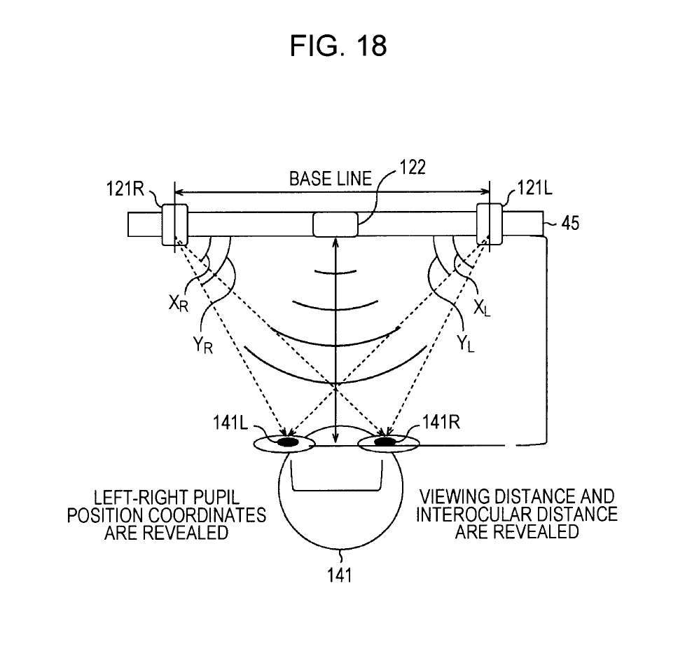

The detection unit 123 detects the pupil positions of the left and right pupils of the user based on the imaging result from the camera 121R and the camera 121L and supplies the pupil positions to the calculation unit 124. Here, the detection method of the pupil positions will be described in detail with reference to FIGS. 17 and 18.

The calculation unit 124 calculates the interocular distance pc of the user and the viewing distance to the user based on the pupil positions from a pupil position detection unit 121 and supplies the interocular distance pc and the viewing distance sc to the image processing unit 44.

[Outline of Processes that Television Set 101 Performs]

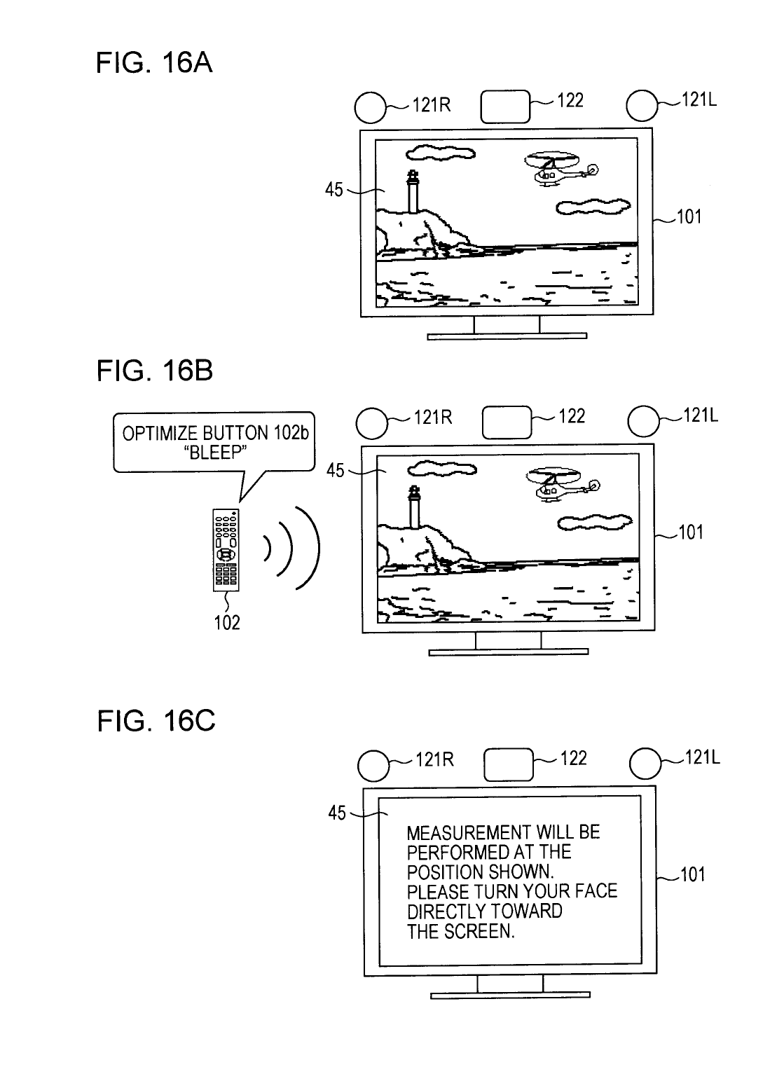

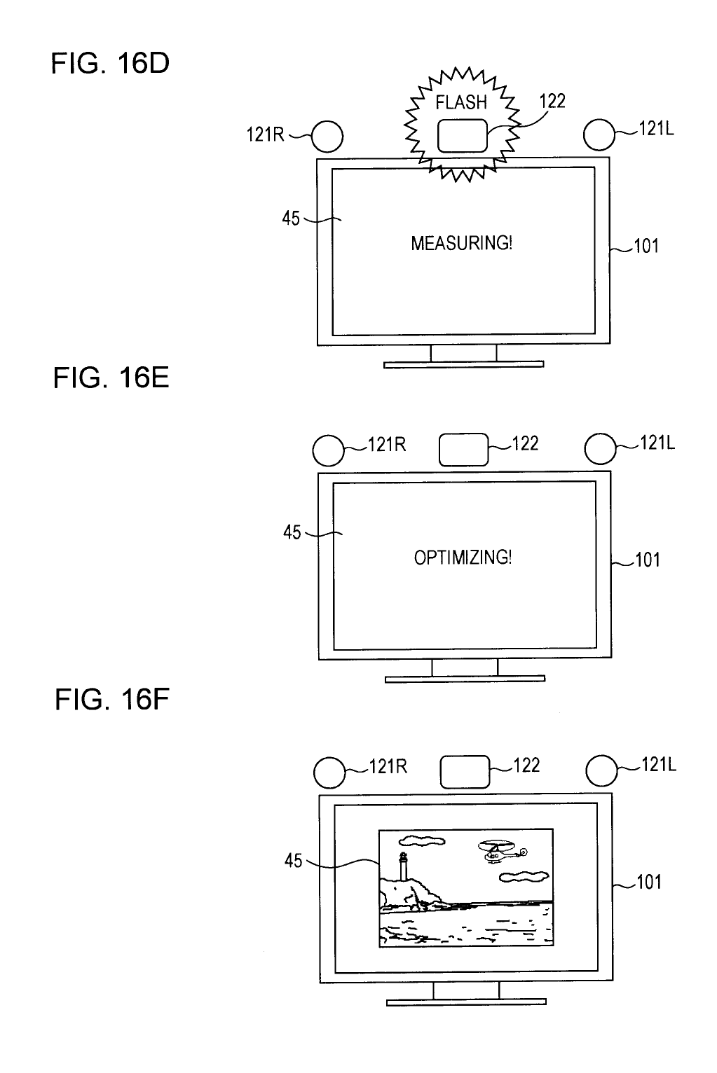

Next, FIGS. 16A to 16F illustrate an outline of processes that the television set 101 performs.

Here, a case when the television set 101 performs a second size adjustment process of changing the size of the three-dimensional image will be described. However, otherwise, the television set 101 is able to perform, for example, a guiding process or the like similarly to the television set 21.

The second size adjustment process is started, for example, when the user is viewing the content displayed on the display 45 of the television set 101 as illustrated in FIG. 16A, the optimize button 102b of the remote controller 102 is pressed as illustrated in FIG. 16B.

As illustrated in FIG. 16C, the display 45 displays a message that “Measurement will be performed at the position shown. Please turn your face directly toward the screen.” according to an operation by the user of pressing the optimize button 102b.

As illustrated in FIG. 16D, the display 45 then displays the message “Measuring!” and the light emitting unit 122 emits light as a flash to the user in front of the display 45. Further, the camera 121R and the camera 121L respectively perform imaging of the user while the light emitting unit 122 emits light.

Furthermore, as illustrated in FIG. 16E, the display 45 displays the message “Optimizing!”. At this time, the television set 101 calculates the recommended screen size of the display 45 based on the imaging result of the camera 121R and the camera 121L.

As illustrated in FIG. 16F, after calculating the recommended screen size, the television set 101 causes a three-dimensional image to be displayed on the display 45 in the recommended size that is calculated.

### [Example of Detection Method of Pupil Positions]

Next, an example in a case when the detection unit 123 detects the pupil positions of the left and right pupils of a user 141 based on the imaging results by the camera 121R and the camera 121L will be described with reference to FIGS. 17 and 18.

As illustrated in FIG. 17, the camera 121L images the user 141 within an imaging range 161L of an angle of view of 90 degrees. The camera 121L performs imaging while the light emitting unit 122 emits light, and supplies a red eye image 181L that is obtaining by the imaging to the detection unit 123.

Further, as illustrated in FIG. 17, the camera 121R images the user 141 within an imaging range 161R of an angle of view of 90 degrees. The camera 121R performs imaging while the light emitting unit 122 emits light, and supplies a red eye image 181R that is obtaining by the imaging to the detection unit 123.

Here, pupils 141R and 141L of the user 141 are displayed on the red eye image 181L and the red eye image 181R in a state of appearing red.

The detection unit 123 detects a pupil region 141R₁ that represents the pupil 141R that is shown in a state of appearing red from a face region 181La that represents the face portion of the user 141 out of all the regions of the red eye image 181L from the camera 121L.

Here, the detection unit 123 detects the face region 181La in advance from an imaged image that is obtaining by the imaging of the camera 121L before the light emitting unit 122 emits light. The detection unit 123 detects, for example, skin-colored regions as the face region 181La.

Here, the camera 121L uses an isometric projection system lens in which an angle α_{L} (degrees) and a distance α_{L} (mm) from an end portion 181Lb of the red eye image 181L to (the center of gravity of) the pupil region 141R₁ match.

Therefore, the detection unit 123 calculates the distance α_{L} (mm) from the end portion 181Lb to the pupil 141R₁ as the angle α_{L} (degrees). The detection unit 123 then calculates an angle X_{L} (=α_{L}+45) by adding 45 (degrees) to the calculated angle α_{L} (degrees).

Further, the detection unit 123 detects a pupil region 141R₂ that represents the pupil 141R in a state of appearing red from a face region 181Ra that represents the face portion of the user 141 out of all the regions of the red eye image 181R from the camera 121R.

Here, the detection unit 123 detects the face region 181Ra in advance from an imaged image that is obtaining by the imaging of the camera 121R before the light emitting unit 122 emits light. The detection unit 123 detects, for example, skin-colored regions as the face region 181Ra.

Here, the camera 121R uses an isometric projection system lens in which an angle α_{R} (degrees) and a distance α_{R} (mm) from an end portion 181Rb of the red eye image 181R to (the center of gravity of) the pupil region 141R₂ match.

Therefore, the detection unit 123 calculates the distance α_{R} (mm) from the end portion 181Rb to the pupil 141R₂ as the angle α_{R} (degrees). The detection unit 123 then calculates an angle X_{R} (=α_{R}+45) by adding 45 (degrees) to the calculated angle α_{R} (degrees).

In so doing, the detection unit 123 calculates the angles X_{R} and X_{L} illustrated in FIG. 18 and detects the pupil position of the pupil 141R using the Pythagorean theorem with the distance between the camera 121R and the camera 121L as the base line.

Further, the detection unit 123 calculates angles Y_{R} and Y_{L} illustrated in FIG. 17 and detects the pupil position of the pupil 141L using the Pythagorean theorem with the distance between the camera 121R and the camera 121L as the base line.

The detection unit 123 supplies the pupil positions that are respectively detected of the pupil 141R and the pupil 141L to the calculation 124.

### [Description of Actions of Television Set 101]

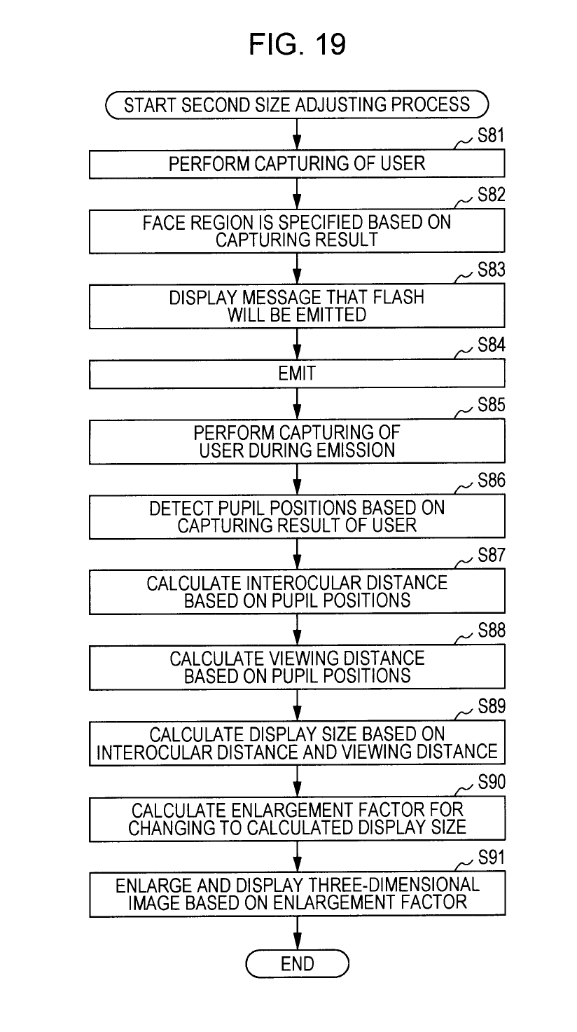

Next, a second size adjustment process that the television set 101 performs will be described with reference to the flowchart of FIG. 19.

The second size adjustment process is started, for example, when the user presses the optimize button 102b of the remote controller 102 while the content is being displayed on the display 45 of the television set 101.

In step S81, the camera 121L performing imaging of the user and supplies a first imaged image that is obtained as a result to the detection unit 123. Further, the camera 121R performs imaging of the user and supplies a second imaged image that is obtained as a result to the detection unit 123.

In step S82, the detection unit 123 detects the face region 181La in the first imaged image based on the first imaged image from the camera 121L. Further, the detection unit 123 detects the face region 181Ra in the second imaged image based on the second imaged image from the camera 121R.

In step S83, the image processing unit 44 controls the display 45 and causes a message that light will be emitted as a flash to be displayed, and in step S84, the light emitting unit 122 emits lights as a flash.

In step S85, the camera 121L performs imaging of the user while the light emitting unit 122 emits light and supplies the red eye image 181L that is obtained as a result to the detection unit 123. Further, the camera 121R performs imaging of the user while the light emitting unit 122 emits light and supplies the red eye image 181R that is obtained as a result to the detection unit 123.

In step S86, the detection unit 123 detects the pupil position of the pupil 141L and the pupil position of the pupil 141R based on the face region 181La in the red eye image 181L from the camera 121L and the face region 181Ra in the red eye image 181R from the camera 121R and supplies the pupil position to the calculation unit 124.

In step S87, the calculation unit 124 calculates the interocular distance based on the pupil positions of the left and right pupils of the user from the detection unit 123 and supplies the interocular distance to the image processing unit 44.

In step S88, the calculation unit 124 calculates the viewing distance based on the three-dimensional position of the television set 101 and the pupil positions (three-dimensional positions) of the left and right pupils of the user from the detection unit 123 and supplies the viewing distance to the image processing unit 44. Here, the calculation unit 124 retains the three-dimensional position of the television set 101 in an in-built memory (not shown) in advance.

In steps S89 to S91, the image processing unit 44 performs the same processes as steps S64 to S66 of FIG. 14 based on the interocular distance and the viewing distance from the calculation unit 124. The second size adjustment process is then ended.

As described above, in the second size adjustment process the interocular distance of the user and the viewing distance are calculated without the user having to wear the 3D glasses 22. Furthermore, the size of the three-dimensional image that is displayed on the display 45 is changed to the recommended screen size based on the calculated interocular distance and viewing distance.

Therefore, for example, it is possible to view the content as a three-dimensional image with the stereoscopic effect that the creator of the content intended without the bother of having to wear the 3D glasses 22.

Further, for example, in the second size adjustment process, by repeating the processes of steps S81 to S86 a plurality of times, the mode interocular distance of the plurality of interocular distance that are obtained as a result may be calculated as the final interocular distance. In such a case, as compared to a case when the processes of step S81 to S86 are only performed once, it is possible to improve the accuracy of the interocular distance that is calculated.

Here, in the second size adjustment process, by performing the process of steps S81 to S86 a plurality of times, the average of the plurality of interocular distances that are obtained as a result may become the final interocular distance.

Further, although the interocular distance of the user and the viewing distance are calculated by using the two cameras 121R and 121L in the second embodiment, the calculation method of the interocular distance of the user and the viewing distance is not limited thereto.

That is, the viewing distance may be calculated, for example, by providing a range sensor as with the viewing distance measuring unit 43 of FIG. 1 on the television set 101.

Further, in the television set 101, for example, the interocular distance may be calculated by detecting the width of the face based on the face region that is detected from the imaged image that is obtained by imaging the user and using the fact that there is a certain relationship between the width of the face and the interocular distance.

Furthermore, in the television set 101, for example, the interocular distance of the user may be calculated based on the detection result of detecting the distance between the left and right pupils in the imaged image that is obtained by imaging the user and the viewing distance.

Further, although the second size adjustment process is started, for example, when the user presses the optimize button 102b of the remote controller 102, the trigger that starts the second size adjustment process is not limited thereto.

That is, for example, the second size adjustment process may be started after a predetermined amount of time elapses after the power of the television set 101 is turned ON, or may be started during a commercial break of a program that is the content.

Further, in the television set 101, in a case when a plurality of users are viewing the content at the same time, the content may be enlarged by the smallest enlargement factor of a plurality of enlargement factors that are calculated for each user and displayed on the display 45. In such a case, it is possible to prevent a situation in which the stereoscopic effect of a three-dimensional image as the content is felt too strongly by any of the users.

Furthermore, in the television set 101, in a case when a plurality of users are viewing the content at the same time, the content may be enlarged by the average of the plurality of enlargement factors that are calculated for each user and displayed on the display 45.

### 3. Modified Example

Although a case when a three-dimensional image is displayed on the display 45 has been described in the first and second embodiments, the technique of the embodiments of the present disclosure is also able to be applied in a case when a two-dimensional image is displayed on the display 45.

Here, in a case when a two-dimensional image is displayed on the display 45, the 3D glasses 22 may have a mechanism for measuring the interocular distance of the user provided thereon, and the right eye shutter 22R₁ and the left eye shutter 22L₁, for example, are not provided.

Further, each user is able to view respectively different content using one display 45 by providing the right eye shutter 22R₁ and the left eye shutter 22L₁ on the 3D glasses 22 as is and changing the timing of releasing the blocking for each user.

That is, for example, in a case when a first user views content A and a second user view content B, synchronizing with display timings t1, t2, 13, t4, . . . , for example, the display 45 displays the two-dimensional image of the content A at the display timing t1, the two-dimensional image of the content B at the display timing t2, the two-dimensional image of the content A at the display timing t3, and the two-dimensional image of the content B at the display timing t4, . . . in such an order.

Synchronizing with the display timings t1, t3, . . . , the 3D glasses 22 worn by the first user release the blocking of the field of view by the left eye shutter 22L₁ and the right eye shutter 22R₁. Further, synchronizing with the other display timings t2, t4, . . . , the 3D glasses 22 worn by the first user maintain the blocking of the field of view by the left eye shutter 22L₁ and the right eye shutter 22R₁.

Furthermore, synchronizing with the display timings t2, t4, . . . , the 3D glasses 22 worn by the second user release the blocking of the field of view by the left eye shutter 22L₁ and the right eye shutter 22R₁. Further, synchronizing with the other display timings t1, t3, . . . , the 3D glasses 22 worn by the second user maintain the blocking of the field of view by the left eye shutter 22L₁ and the right eye shutter 22R₁.

Here, in the first embodiment, the 3D glasses 22 calculate the interocular distance of the user. However, for example, other than the interocular distance, the 3D glasses 22 may also calculate the viewing distance and calculate the enlargement factor rdi/vdi based on the calculated interocular distance and viewing distance and the screen diagonal rdi of the display 45 of the television set 21 and transmit the enlargement factor rdi/vdi to the television set 21. Here, in such a case, the 3D glasses 22 may retain the screen diagonal rdi of the display 45 of the television set 21 in advance.

Furthermore, although the image processing unit 44 performs processes with an image that corresponds to an image signal that is obtained based on a broadcast signal from the tuner 41 as the target in the first and second embodiments, for example, the process may be performed with content that is recorded on a recording medium such as a hard disk as the target.

Further, although a case when the technique of the embodiments of the present disclosure is applied to the television set 21 and the television set 101 has been described in the first and second embodiments, otherwise, for example, it is possible to apply the technique of the embodiments of the present disclosure to a mobile phone, a personal computer, or the like.

That is, the technique of the embodiments of the present disclosure is able to be applied to any electronic apparatus that displays content.

Incidentally, the series of processes described above may be executed by hardware or may be executed by software. In a case when the series of processes are executed by software, a program that configures the software is installed from a program recording medium onto a computer that is build into specialized hardware or a general-purpose computer that is able to execute various functions by installing various programs.

### [Configuration Example of Computer]

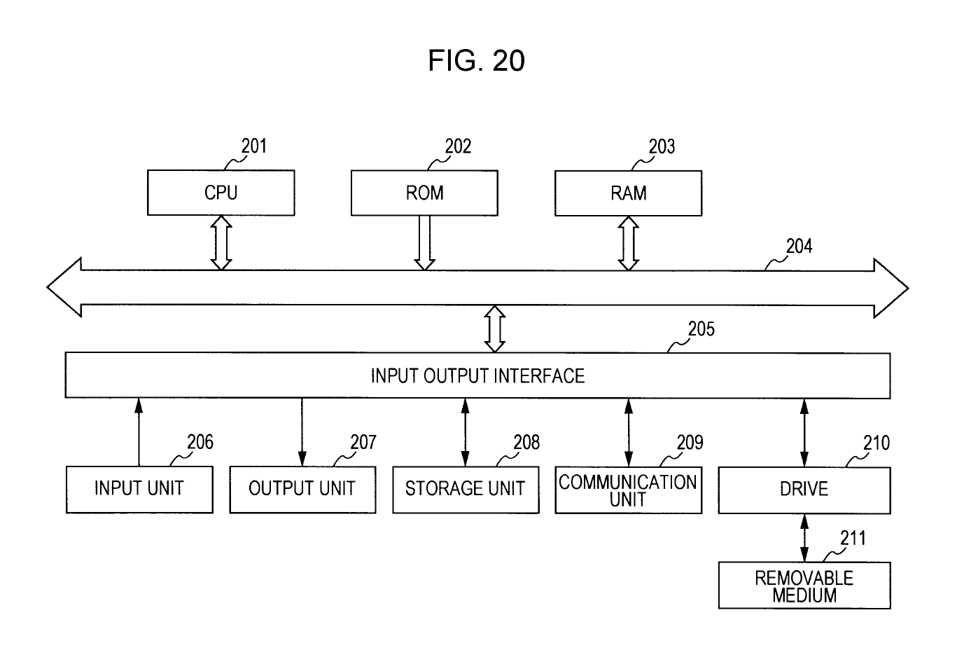

FIG. 20 illustrates a configuration example of the hardware of a computer that executes the series of processes described above by a program.

A CPU (Central Processing Unit) 201 executes the various processes according to a program that is stored on a ROM (Read Only Memory) 202 or a storage unit 208. The program that the CPU 201 executes, data, and the like are stored as appropriate in a RAM (Random Access Memory) 203. The CPU 201, the ROM 202, and the RAM 203 are connected to each other by a bus 204.

Further, an input output interface 205 is connected to the CPU 201 via the bus 204. An input unit 206 composed of a keyboard, a mouse, a microphone, and the like and an output unit 207 composed of a display, a speaker, and the like are connected to the input output interface 205. The CPU 201 executes various processes according to instructions that are input from an input unit 206. Furthermore, the CPU 201 outputs the results of the processes to an output unit 207.

The storage unit 208 that is connected to the input output interface 205 is composed, for example, of a hard disk, and stores the program that the CPU 201 executes and various pieces of data. A communication unit 209 communicates with an external device via a network such as the Internet or a local area network.

Further, a program may be obtained via the communication unit 209 and stored in the storage unit 208.

When a removable medium 211 such as a magnetic disk, an optical disc, a magneto optical disc, or a semiconductor memory is fitted, a drive 210 that is connected to the input output interface 205 drives the removable medium 211 and obtains a program, data, or the like that is recorded therein. The program or the data that is obtained is transferred to the storage unit 208 as necessary and stored.

As illustrated in FIG. 20, a recording medium that records (stores) a program that is installed on a computer and which is in a state of being executable by the computer is configured by the removable medium 211 that is a packaged medium composed of a magnetic disk (includes flexible disks), an optical disc (includes CD-ROMs (Compact Disc-Read Only Memory) and DVDs (Digital Versatile Disc)), a semiconductor memory, or the like, the ROM 202 in which a program is temporarily or indefinitely stored, a hard disk that configures the storage unit 208, or the like. The recording of a program on a recording medium is performed using a wired or wireless communication medium such as a local area network, the Internet, or a digital satellite broadcast via the communication unit 209 that is an interface such as a router, a modem, or the like as necessary.

Here, in the specification, the steps that describe the series of processes described above may not only be processed in a time series manner in the order described but also include processes that are executed in parallel or individually without necessarily being processed in a time series manner.

Here, the embodiments of the present disclosure are not limited to the first and second embodiments described above, and various modifications are possible within a scope of not departing from the gist of the embodiments of the present disclosure.

For example, the present technology can adopt the following configurations.

(1) A display control device comprising:

a content obtaining unit that obtains content that is configured by an image;

a display control unit that causes the content to be displayed on a display unit;

an interocular distance obtaining unit that obtains an interocular distance that represents a distance between left and right pupils of a user that views the content; and

a process execution unit that performs a predetermined process based on the interocular distance.

(2) The display control device according to the (1), further comprising:

a viewing distance obtaining unit that obtains a viewing distance that represents a distance to the user,

wherein the process execution unit performs a process of generating second content that is obtained by changing first content that is obtained by the content obtaining unit based on the interocular distance and the viewing distance, and

the display control unit causes each image that configures the second content to be displayed on the display unit.

(3) The display control device according to the (2),

wherein the process execution unit performs a process of generating the second content that is obtained by changing a size of each image that configures the first content to a size based on the interocular distance and the viewing distance.

(4) The display control device according to the (2),

wherein the content obtaining unit obtains the first content that is configured by a three-dimensional image composed of a left eye two-dimensional image that is seen by a left eye of the user and a right eye two-dimensional image seen by a right eye of the user, and

the process execution unit performs a process of generating the second content that is obtained by changing a parallax amount that represents a size of parallax that is provided between the left eye two-dimensional image and the right eye two-dimensional image to a parallax amount based on the interocular distance and the viewing distance for each three-dimensional image that configures the first content.

(5) The display control device according to any one of the (1) to (4),

wherein the process execution unit performs a process of presenting a message that is determined based on the interocular distance to the user by at least one of an image and a sound.

(6) The display control device according to the (5),

wherein the process execution unit performs a process of presenting the message prompting to view the content away by a distance according to the interocular distance by at least one of an image and a sound.

(7) The display control device according to any one of the (2) to (6),

wherein respectively for a plurality of the users, fields of view of the users are restricted, and a device for releasing restrictions on the fields of view by different timings for each of the users is worn, and

the display control unit causes each image that configures the second content that the users view to be synchronized and displayed at different timings for each of the users.

(8) The display control device according to any one of the (1) to (7),

wherein the interocular distance obtaining unit receives and obtains the interocular distance that is transmitted from a transmission device that is worn by the user when viewing the content.

(9) The display control device according to any one of the (1) to (8),

wherein the interocular obtaining unit calculates and obtains an interocular distance of the user, and

the viewing distance obtaining unit calculates and obtains the viewing distance.

(10) A display control method of a display control device that causes content that is configured by an image to be displayed, the method by the display control device comprising:

obtaining content that is configured by a plurality of images;

controlling to cause the content to be displayed on a display unit;

obtaining an interocular distance that represents a distance between left and right pupils of a user that views the content; and

executing a predetermined process based on the interocular distance.

(11) A program causing a computer to execute processes including:

obtaining content that is configured by an image;

controlling to cause the content to be displayed on a display unit;

obtaining an interocular distance that represents a distance between left and right pupils of a user that views the content; and

executing a predetermined process based on the interocular distance.

(12) The program according to the (11), further comprising:

obtaining a viewing distance that represents a distance to the user,

wherein the executing performs a process of generating second content that is obtained by changing first content that is obtained by the content obtaining unit based on the interocular distance and the viewing distance, and

the controlling causes the second content to be displayed on the display unit.

(13) The program according to the (12),

wherein the executing performs a process of generating the second content that is obtained by changing a size of each image that configures the first content to a size based on the interocular distance and the viewing distance.

(14) The program according to the (12),

wherein the obtaining of the content obtains the first content that is configured by a three-dimensional image composed of a left eye two-dimensional image that is seen by a left eye of the user and a right eye two-dimensional image seen by a right eye of the user, and

the executing performs a process of generating the second content that is obtained by changing a parallax amount that represents a size of parallax that is provided between the left eye two-dimensional image and the right eye two-dimensional image to a parallax amount based on the interocular distance and the viewing distance for each three-dimensional image that configures the first content.

(15) The program according to the any one of the (11) to (14),

wherein the executing performs a process of presenting a message that is determined based on the interocular distance to the user by at least one of an image and a sound.

(16) A detection device that is worn by a user when viewing content, the device comprising:

an interocular distance detection unit that detects an interocular distance that represents a distance between left and right pupils of the user; and

a transmission unit that transmits the interocular distance.

(17) The detection device according to the (16), further comprising:

a first sheet-like member that is moved to a position of a left pupil of the user;

a second sheet-like member that is moved to a position of a right pupil of the user; and

a movable bridge that expands and contracts according to a positioning of the first sheet-like member and the second sheet-like member,

wherein the interocular distance detection unit detects an interocular distance of the user based on a length of the movable bridge.

(18) The detection device according to the (16), further comprising:

a viewing distance calculation unit that calculates the viewing distance,

wherein the transmission unit also transmits the viewing distance.

(19) A detection method of a detection device that is worn by a user when viewing content, the method by the detection device comprising:

detecting an interocular distance that represents a distance between left and right pupils of the user; and

transmitting the interocular distance.

(20) A display system configured by a detection device that is worn by a user and a display control device that causes content that is viewed by the user to be displayed,

wherein the detection device includes

an interocular distance detection unit that detects an interocular distance that represents a distance between left and right pupils of the user, and

a transmission unit that transmits the interocular distance,

wherein the display control device includes

a content obtaining unit that obtains content that is configured by an image,

a display control unit that causes the content to be displayed on a display unit,

an interocular distance receiving unit that receives the interocular distance that is transmitted from the transmission unit, and

a process execution unit that performs a predetermined process based on the interocular distance.

What is claimed is:

1. An information processing apparatus comprising:
an interface that acquires information indicating a distance between a right eye and a left eye of a person; and
a processor that determines a recommended viewing condition for a display based on the information indicating the distance between the right eye and the left eye of the person.

2. The information processing apparatus of claim 1, wherein
the display displays a three-dimensional (3-D) image.

3. The information processing apparatus of claim 2, further comprising:
the display that displays the 3-D image.

4. The information processing apparatus of claim 1, wherein
the interface receives the information indicating the distance between the right eye and the left eye of the person from a detection device worn by the person.

5. The information processing apparatus of claim 1, wherein
the processor obtains a viewing distance between the person and the display.

6. The information processing apparatus of claim 1, wherein
the processor controls the display to display a notification corresponding to the recommended viewing condition for the display.

7. The information processing apparatus of claim 1, wherein
the processor determines, as the recommended viewing condition, a recommended viewing distance between the person and the display based on the distance between the right eye and the left eye of the person and a size of the display.

8. The information processing apparatus of claim 7, wherein
the processor controls the display to display a notification corresponding to the determined recommended viewing distance.

9. The information processing apparatus of claim 7, wherein
the processor obtains a viewing distance between the person and the display.

10. The information processing apparatus of claim 9, wherein
the processor determines a difference between the recommended viewing distance and the obtained viewing distance and compares the difference to a threshold value.

11. The information processing apparatus of claim 10, wherein
the processor controls the display to display a notification instructing the person to move to a distance corresponding to the recommended viewing distance when the difference is greater than the threshold value.

12. The information processing apparatus of claim 10, wherein
the processor control the display to display a notification indicating that the person is in a correct position when the difference is less than the threshold value.

13. The information processing apparatus of claim 5, wherein
the processor determines, as the recommended viewing condition, a recommended display size of the display based on the distance between the right eye and the left eye of the person and the obtained viewing distance.

14. The information processing apparatus of claim 13, wherein
the processor determines a size adjustment of an image displayed on the display based on the recommended display size and a size of the display and applies the size adjustment to the image displayed on the display.

15. The information processing apparatus of claim 5, wherein
the processor determines a parallax adjustment between a right-eye image and a left-eye image of a three-dimensional (3-D) image displayed on the display based on the distance between the right eye and the left eye of the person, the obtained viewing distance and a size of the display, and controls the display to display the 3-D image in accordance with the determined parallax adjustment.

16. The information processing apparatus of claim 1, wherein
the interface is a user interface including a plurality of cameras that respectively acquire a plurality of images of the person, and
the processor determines the distance between the right eye and the left eye of the person based on the acquired plurality of images.

17. A method performed by an information processing apparatus, the method comprising:
acquiring, by an interface of the information processing apparatus, information indicating a distance between a right eye and a left eye of a person; and
determining, by a processor of the information processing apparatus, a recommended viewing condition for a display based on the information indicating a distance between the right eye and the left eye of the person.

18. A non-transitory computer-readable medium including computer program instructions, which when executed by an information processing apparatus, cause the information processing apparatus to perform a method comprising:
acquiring information indicating a distance between a right eye and a left eye of a person; and
determining a recommended viewing condition for a display based on the information indicating a distance between the right eye and the left eye of the person.

19. A detection device comprising:
a processor that determines information corresponding to a distance between a right eye and a left eye of a person; and
an interface that outputs the information corresponding to the distance to another device that determines a recommended viewing condition for a display based on the information indicating a distance between the right eye and the left eye of the person.

20. The detection device of claim 19, further comprising:
an adjustable member, wherein the processor determines the information corresponding to the distance between the right eye of the person and the left eye of the person based on a setting of the adjustable member.

21. A detection method performed by a detection device, the detection method comprising:
determining, by a processor of the detection device, information corresponding to a distance between a right eye and a left eye of a person; and
outputting, by an interface of the detection device, the information corresponding to the distance to another device that determines a recommended viewing condition for a display based on the information indicating a distance between the right eye and the left eye of the person.
